(19) United States
(12) Patent Application Publication
(10) Pub. No.: US 2012/0205440 A1
(43) Pub. Date: Aug. 16, 2012

(54) DATA COLLECTION SYSTEM, MOBILE TERMINAL, STICKER, AND DATA COLLECTION METHOD

(75) Inventor: Ryuhei Fujiwara, Tokyo (JP)

(73) Assignee: NEC CORPORATION, Tokyo (JP)

(21) Appl. No.: 13/501,769

(22) PCT Filed: Oct. 13, 2010
(86) PCT No.: PCT/JP2010/067912

§ 371 Date: Apr. 13, 2012

(30) Foreign Application Priority Data
Oct. 14, 2009 (JP) 2009-237616

(51) Int. Cl. G06F 17/40; G06K 19/00

(52) U.S. Cl. 235/375; 235/487

(57) ABSTRACT

A data collection system includes: an image input means; a code deciphering means; an image analysis means; and a server. The image input means is installed in a mobile terminal and acquires an analysis object image as an analysis object which is an image in a display device. The code deciphering means retrieves a code image portion which is an image of an optically readable code provided correspondingly to the analysis object from the analysis object image and extracts a description of the code from the code image portion. The image analysis means selects an image analysis algorithm based on image classification data included in the description of the code and extracts indication data of the display device by performing image analysis on the analysis object image using the selected image analysis algorithm. The server includes a data storage section which stores the indication data and is capable of communicating with the mobile terminal.

### TECHNICAL FIELD

The present invention relates to a data collection system, a mobile terminal, a sticker, and a data collection method, and more particularly relates to a system which collects data by capturing an image by using a mobile terminal.

### BACKGROUND ART

Recently, a liquid crystal digital display has been widely applied to low price device for the general public such as healthcare device like a user-friendly thermometer and a game machine. It is expected that new values are created by reading and collecting such various indication data and analyzing a personal activity pattern based on the collected data.

On the other hand, recently, a mobile terminal such as a camera equipped cellular phone and the like has been able to receive an image of a display section, a bar-code or a two-dimensional bar-code of a measuring instrument and performs a numeric recognition, a code analysis or the like by image processing. As the technique described above, a patent literature 1 discloses, for reducing a load of data input by hand, a meter check system which includes a management server and a camera equipped cellular phone capable of communicating with the management server through a communication network. In this meter check system, the management server includes a customer database and a used amount database which recodes a value of a measurement meter for each month. The camera equipped cellular phone transmits a captured image of a display screen of the measurement meter by e-mail. The management server calculates a used amount by reading the value of the measurement meter based on character recognition on the received image. In addition, a patent literature 2 discloses, for reducing a load of read image analysis processing, a mobile information terminal device includes a frame displaying program which displays a frame in a display section such that a read area can be recognized to be seen.

### CITATION LIST

### Patent Literature

### [PTL 1] JP2009-037279

### [PTL 2] JP2004-287808

### SUMMARY OF INVENTION

An object of the present invention is to provide a data collection system that can capture indication information, which diverse electric devices not having a data transmitting function such as a pedometer or a water meter indicates toward a person, by using a camera equipped mobile terminal, analyze the captured indication information and collect the result at a desired server.

By capturing an indication of an electric device and an image code arranged around the indication of the device simultaneously as an image and performing analysis processing of the device indication image by the terminal and the server in a sharing manner based on an analysis algorithm indicating the image code, information such as a collection server address and the like, operability of the terminal, diversity of the indication in the device and applicability to information application system can be remarkably improved.

In an aspect of the present invention, a data collection system includes: an image input means configured to be installed in a mobile terminal and acquire an analysis object image as an analysis object which is an image in a display device; a code deciphering means configured to retrieve a code image portion which is an image of an optically readable code provided correspondingly to the analysis object from the analysis object image and extract a description of the code from the code image portion; an image analysis means configured to select an image analysis algorithm based on image classification data included in the description of the code and extract indication data of the display device by performing image analysis on the analysis object image using the selected image analysis algorithm; and a server configured to include a data storage section which stores the indication data and be capable of communicating with the mobile terminal.

In another aspect of the present invention, a mobile terminal includes: an image input means configured to acquire an analysis object image as an analysis object which is an image in a display device; a code deciphering means configured to retrieve a code image portion which is an image of an optically readable code provided correspondingly to the analysis object from the analysis object image and extract a description of the code from the code image portion; an image analysis means configured to select an image analysis algorithm based on image classification data included in the description of the code and perform image analysis on the analysis object image using the selected image analysis algorithm; and a wireless transmitting and receiving section configured to transmit data obtained by the image analysis to a server.

In still another aspect of the present invention, a sticker that is used for collecting data from a display device includes: a first frame; a code configured to be provided inside the first frame and optically readable; a second frame configured to be provided inside the first frame and located at a position corresponding to the display device. In the code, image classification data corresponding to an image analysis algorithm to be used for an image of the display device is described.

In still another aspect of the present invention, a data collection method includes: acquiring an analysis object image as an analysis object which is an image in a display device by an image input means installed in a mobile terminal; retrieving a code image portion which is an image of an optically readable code provided correspondingly to the analysis object from the analysis object image; extracting a description of the code from the code image portion; selecting an image analysis algorithm based on image classification data included in the description of the code; extracting indication data of the display device by performing image analysis on the analysis object image using the selected image analysis algorithm; and storing the indication data in a server.

According to the present invention, based on each of diverse images, information contained in the image can be easily collected and transmitted to a desired server.

### BRIEF DESCRIPTION OF DRAWINGS

FIG. 1 is a block diagram illustrating a configuration of a data collection system of an embodiment and its first application example according to the present invention;

FIG. 2 is a block diagram illustrating a configuration of a data collection system of the embodiment and its second application example according to the present invention;

FIG. 3 is a block diagram illustrating a configuration of a camera equipped cellular phone of the embodiment according to the present invention;

FIG. 4 is a block diagram illustrating a configuration of a data server of the embodiment according to the present invention; and

FIG. 5 is a block diagram illustrating a configuration of a camera equipped cellular phone of another embodiment according to the present invention.

### DESCRIPTION OF EMBODIMENTS

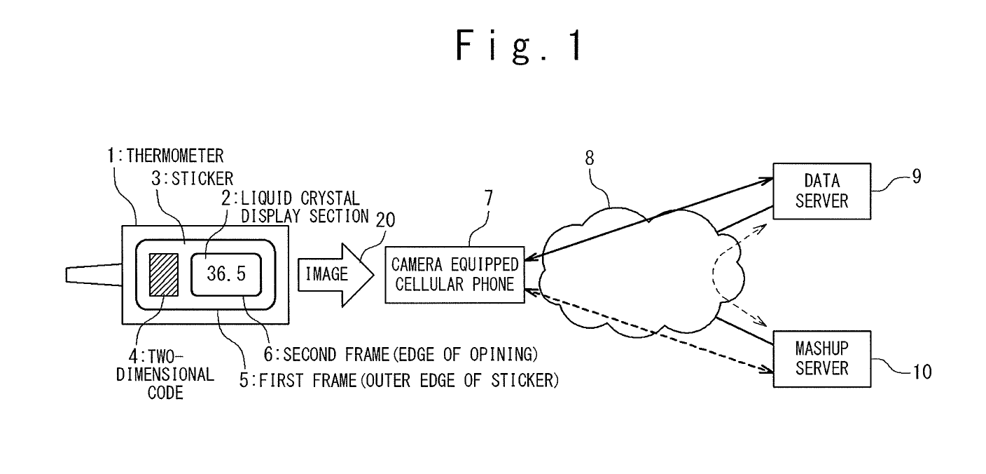

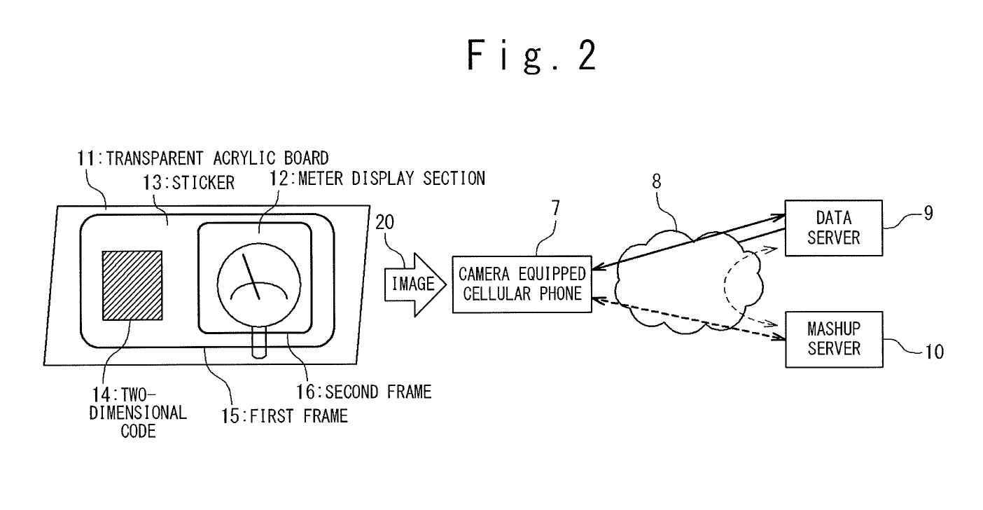

FIGS. 1 and 2 are block diagrams each illustrating a configuration of a data collection system of an embodiment according to the present invention. The data collection system of the present embodiment is the system which collects data by using a mobile terminal and stores the collected data in a server. Specifically, the data collection system includes a camera equipped cellular phone 7, a data server 9 and a mashup server 10. The camera equipped cellular phone 7 acquires an image 20 by taking an image of a display device, which is an object of image processing, and perform the image processing on the image 20. The data obtained by performing the image processing is transmitted from the camera equipped cellular phone 7 to the data server 9 through a network 8.

The data collection system of the present embodiment is configured so as to collect indication data from a variety of display devices while commonly using the camera equipped cellular phone 7. FIG. 1 shows an application example of the system which reads indication data from a household electrical appliance with a liquid crystal digit indication to store for personal data and uses the read indication data for a healthcare service. In the application example of FIG. 1, the indication data is read from a thermometer 1 and is accumulated. Meanwhile, FIG. 2 shows an application example of the system which reads indication data from a meter display section 12 of a meter (e.g., a weight scale) and manages the read indication data.

In the display device of the data collection origin, marks are provided for making data reading easy. Specifically, in the application example of FIG. 1 in which the indication data is read from a liquid crystal display section 2 of the thermometer 1, a sticker 3 is attached on the thermometer 1. In the sticker 3, an opening is provided at a position corresponding to the liquid crystal display section 2. A first frame 5 and a second frame 6 are printed at the outer edge of the sticker 3 and the edge of the opining, respectively. In the reading of the data from the liquid crystal display section 2 of the thermometer 1, the first frame 5 and the second frame 6 are used for distinguishing a position of an object of an image processing. In addition, inside the first frame 5, a two-dimensional code 4 is printed. The two-dimensional code 4 includes: image classification data indicative of an image classification (a character, an outline shape and so on) indicated in the liquid crystal display section 2; and a description (e.g., a description indicative of an information type, a server name, a port number, an URL showing a folder name and a file name and so on) indicative of a place where data read from the thermometer 1 should be accumulated. Here, in the present embodiment, the two-dimensional code 4 is used. However, also, another optically readable code (e.g., a normal bar-code) can be used instead. Using the two-dimensional code is preferable in light of improvement of an information storage density.

Meanwhile, in the application example of FIG. 2 in which the data is read from the meter display section 12 of the meter, the image is captured under a situation that a transparent acrylic board 11 is arranged in front of the meter. A sticker 13 similar to the sticker 3 is attached on the transparent acrylic board 11. On the sticker 13, a first frame 15 and a second frame 16 are printed. In the reading of the data from the meter display section 12, the first frame 15 and the second frame 16 are used for distinguishing a position of an object of an image processing. In addition, inside the first frame 15, a two-dimensional code 14 is printed. The two-dimensional code 14 includes: information indicative of an image classification (a character, an outline shape and so on) indicated in the meter display section 12; and a description (e.g., a description indicative of an information type, a server name, a port number, an URL showing a folder name and a file name and so on) indicative of a place where data read from the meter display section 12 should be accumulated. The application example using the transparent acrylic board 11 is suitable for a case that data is read from a device which is not adequate for a sticker being attached on because it has a concavo-convex surface on a housing and so on. Here, even though the transparent acrylic board 11 is used in FIG. 2, it is obvious for a person skilled in the art that a board made of transparent material other than acrylic such as glass can be used.

Here, note that, in both of FIGS. 1 and 2, the two-dimensional code (4 or 14), in which the information indicative of the image classification is described, is provided near the image processing object and the image processing object is preliminarily specified by the first frame (5 or 15) and the second frame (6 or 16). In the data collection system of the present embodiment, the reading of the data can be easily performed by using the two-dimensional code and the two frames.

The indication data read from the liquid crystal display section 2 of the thermometer 1 and the indication data read from the meter display section 12 of the meter are accumulated and stored in the data server 9. The mashup server 10 provides a mashup service for effectively using the data stored in the data server 9. The mashup server 10 acquires the accumulated personal data from the data server 9 through the network 8 and provides the healthcare service to users through a browser in the cellular phone 7. The mashup service is well known technique for a person skilled in the art and therefore its detail is not described here.

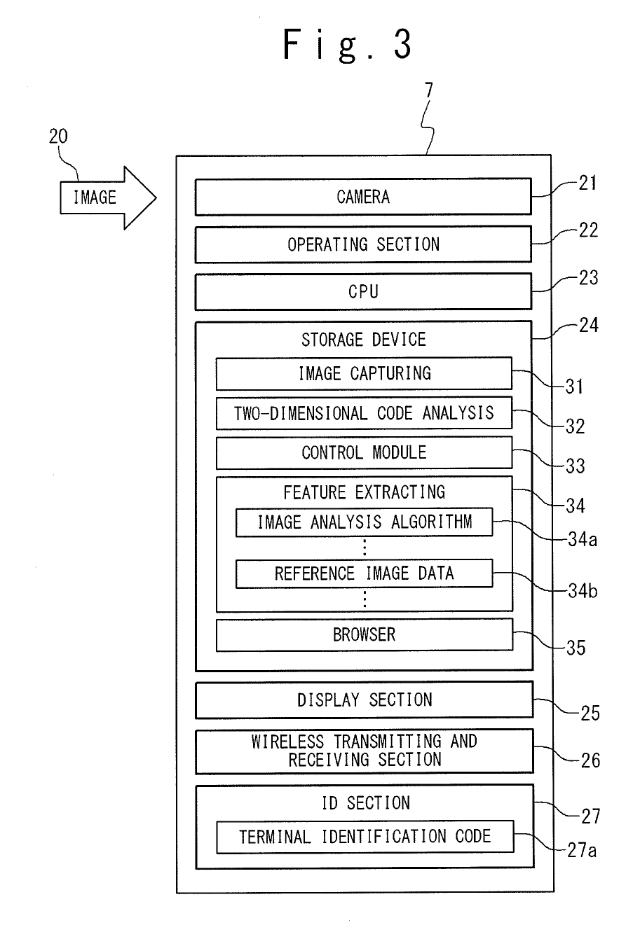

FIG. 3 is a block diagram showing a configuration of the camera equipped cellular phone 7. The cellular phone 7 includes a camera 21, an operating section 22, a CPU 23, a storage device 24, a display section 25, a wireless transmitting and receiving section 26 and an ID section 27. The camera 21 is used for taking an image of a display device (e.g., the liquid crystal display section 2 of the thermometer 1, the meter display section 12 of the meter). The operating section 22 and the display section 25 function as man-machine interfaces of the cellular phone 7. The wireless transmitting and receiving section 26 is used for performing communication through the network 8. The ID section 27 is a memory storing a terminal identification code 27a assigned to the cellular phone 7. The terminal identification code 27a is uniquely defined in the whole data collection system.

In the storage device 24, various software programs are installed, which are necessary for processing of the data collection system. Specifically, in the storage device 24, an image capturing module 31, a two-dimensional code analysis module 32, a control module 33, a feature extracting module 34 and a browser 35 are installed. By executing these software programs using the CPU 23, the camera equipped cellular phone 7 performs desired operations. The two-dimensional code analysis module 32 detects the two-dimensional code 4 or 14 from the image 20 and analyzes it. The feature extracting module 34 extracts features of the image such as an outline and so on from the image 20. The control module 33 provides a communication link individually with the data server 9 and the mashup server 10 and displays data in the mashup server 10 on the display section 25 through the browser 35. For the feature extracting module 34, a plurality of image analysis algorithms and a plurality of reference image data are provided. Reference symbols of 34a and 34b in FIG. 3 show one of the image analysis algorithms and one of the reference image data, respectively.

The feature extracting module 34 of the camera equipped cellular phone 7 selects the image analysis algorithm 34a and the reference image data 34b which are actually used for image analysis based on the image classification described in the two-dimensional code 4 or 14.

Here, the camera equipped cellular phone 7 may perform the image processing on the image 20 independently, or may share the performing of the image processing on the image 20 with the data server 9. When only the light image processing is required, it is preferable that the camera equipped cellular phone 7 performs the image processing independently. On the other hand, when the heavy image processing is required, it is preferable that the camera equipped cellular phone 7 shares the performing of the image processing with the data server 9. Which image processing is selected is determined depends on the image classification described in the two-dimensional code 4 or 14. When the camera equipped cellular phone 7 performs the image processing independently, the data acquired by the image processing is transmitted to the data server 9. On the other hand, when the camera equipped cellular phone 7 shares the performing of the image processing with the data server 9, data acquired on the way by the image processing of the camera equipped cellular phone 7 (e.g., data in which only a portion surrounded by the second frame 6 or 16 is extracted, hereinafter referred to as “intermediate processed image data”) is transmitted to the data server 9. The desired indication data is finally extracted from the intermediate processed image data by the image processing of the data server 9.

Here, preparing the image analysis algorithms and the reference image data for the feature extracting module 34 in the cellular phone 7 such that all of image classification can be treated is not realistic in light of the implementation. For this reason, a necessary image analysis algorithm 34a and necessary reference image data 34b may be downloaded into the cellular phone 7 from the data server 9 or another server (e.g., the mashup server 10).

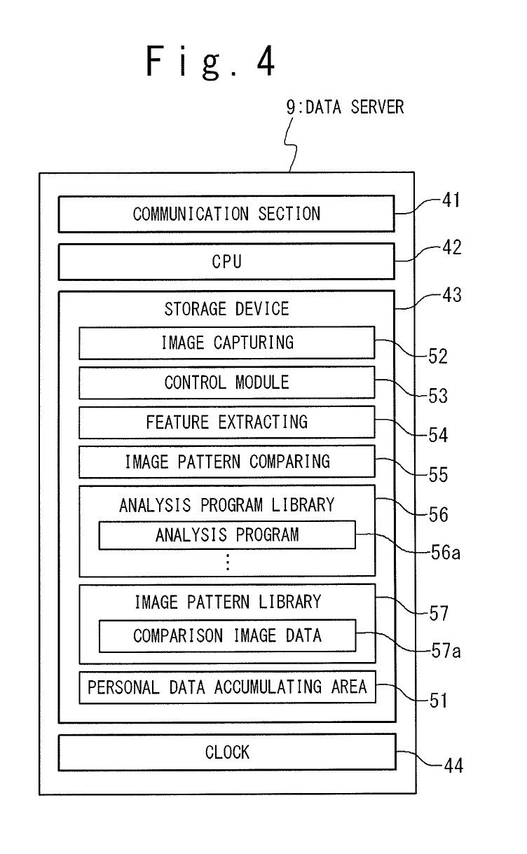

FIG. 4 is a block diagram showing a configuration of the data server 9. The data server 9 includes a communication section 41, a CPU 42, a storage device 43 and a clock 44. In the storage device 43, a personal data accumulating area 51 is provided. In this personal data accumulating area 51, the data collected by the camera equipped cellular phone 7 is accumulated while being associated with the terminal identification code 27a. In addition, into the storage device 43, an image capturing module 52, a control module 53, a feature extracting module 54 and an image pattern comparing module 55 are installed. The image capturing module 52 temporarily accumulates the intermediate processed image data transmitted from the cellular phone 7. The feature extracting module 54 performs feature extraction from the intermediate processed image data by using an analysis program 56a registered in an analysis program library 56. The image pattern comparing module 55 compares image data created based on the feature extraction performed by the feature extracting module 54 with comparison image data registered in an image pattern library 57 to execute similarity analysis. Consequently, desired indication data (numerical data, character data) can be finally taken out.

Next, a procedure of collecting the indication data of the display device by using the cellular phone 7 will be described in detail. First, with reference to FIG. 1, a procedure of collecting the indication data of the liquid crystal display device 2 of the thermometer 1 will be described.

When a user takes an image focusing around the sticker 3 of the thermometer 1 by using the cellular phone 7, the image capturing module 31 of the cellular phone 7 recognizes the first frame 5 included in the image 20, extracts the two-dimensional code 4 from an image inside the first frame 5 and outputs the extracted two-dimensional code 4 to the two-dimensional code analysis module 32. Here, since the existence and the shape of the first frame 5 are preliminarily known, by preparing a recognition algorithm of the image capturing module 31 which is suitable for the first frame 5, the clipping of the image inside the first frame 5 and the extracting the two-dimensional code 4 can be executed accurately. That is, by defining the first frame 5, the image capturing module 31 can be made to recognize an analysis object region in the image 20. In addition, since the shape of the first frame 5 is preliminarily known, accuracy of the clipping of the image can be improved by optical control such as automatic focusing and automatic zooming. Moreover, accuracy of the analysis can be improved by image modification such as keystone correction even if the cellular phone 7 is roughly used at the time of taking images.

The two-dimensional code analysis module 32 performs the image analysis of the two-dimensional code 4 and outputs the extracted data from the two-dimensional code 4 to the control module 33. In the two-dimensional code 4, image classification data indicative of an image inside the second frame 6 and an URL (an address of a server to be connected and the like) which is a data storage location are described. The control module 33 recognizes that the image of the liquid crystal display section 2 inside the second frame 6 is the liquid crystal digit indication and determines that an image processing for numeral recognition by performing pattern matching on the image inside the second frame 6 should be carried out. At this time, the control module 33 determines that the image processing is carried out by the cellular phone 7 independently, assigns the image analysis algorithm 34a and the reference image data 34b used for the pattern matching and notifies the feature extracting module 34 of them.

Meanwhile, the image capturing module 31 recognizes the second frame 6, extracts the image inside the second frame 6 and outputs it to the feature extracting module 34. Here, since the existence and the shape of the second frame 6 are preliminarily known, by preparing a recognition algorithm of the image capturing module 31 suitable for the second frame 6, the clipping of the image inside the second frame 6. That is, by defining the second frame 6, the image capturing module 31 can be made to recognize an analysis object region of the image 20.

The feature extracting module 34 performs the image analysis based on the image analysis algorithm 34a assigned by the control module 33, extracts indication data such as numerals and the like, which is indicated inside the frame, from the liquid crystal display section 2 of the thermometer 1 and outputs it to the control module 33. Furthermore, the control module 33 acquires the URL of the storage location of the indication data from the data extracted from the two-dimensional code 4, and transmits the image classification data, the indication data (numerals and the like) obtained based on the image processing by the feature extracting module 34 and the URL of the storage location to the data server 9 through the wireless transmitting and receiving section 26. At that time, the control module 33 reads out the terminal identification code 27a, which indicates that the cellular phone 7 is unique in the system, from the ID section 27 and attaches it to the data.

The data (the image identification data, the indication data and the terminal identification code 27a) is transmitted to the data server 9 through the network 8. The control module 53 of the data server 9 stores the received data (the image identification data, the indication data and the terminal identification code 27a) into an area specified by the URL of the storage location, in the personal data accumulating area 51 specified by the terminal identification code 27a, every writing time known by the clock 44.

Meanwhile, the cellular phone 7 activates the browser 35 and calls up a web page of the mashup server 10, which is preliminarily known because a user made a service contract. The mashup server 10 reads the personal information of the user of the cellular phone 7, which is accumulated in the personal data accumulating area 51 of the data server 9, edits it as a web page and provides it to the browser for reading. Generally, taking out information in the data server 9 by the mashup server 10 for providing a new service is well known as an application method of a web service called a mashup. The mashup server 10 can provide added value of the thermometer 1 as a new information service which are not only a body temperature at a measuring time but also a notification of biorhythm or a warning of abnormality using past information accumulated in the data server 9.

Next, a procedure of reading the indication data from the meter display section 12 as shown in FIG. 2 will be described. As shown in the example of the thermometer 1 of FIG. 1, in the case that the image inside the second frame 6 is relatively easily recognized like the liquid crystal digit indication, the image analysis can be performed using processing capability of the cellular phone 7. However, in the case that a state of a needle of the meter display section 12 is read, since the load of the feature extracting processing is heavy, there is a problem on the processing capability of the cellular phone 7 for the implementation. Consequently, when the indication data is read from the meter display section 12, the cellular phone 7 shares the performing of the image processing with the data server 9. The detail will be described.

On the transparent acrylic board 11, the sticker 13 similar to the sticker 3 of FIG. 1, on which the first frame 15, the second frame 16 and the two-dimensional code 14 are printed, is attached. By holding the transparent acrylic board 11 over the meter display section 12 such that the meter display section 12 is viewed through the region inside the second frame 16 and taking an image of the meter display section 12 by the cellular phone 7, the indication data that the meter display section 12 indicates can be transmitted to the data server 9.

In detail, when a user takes an image of the meter display section 12 through the sticker 13 of the transparent acrylic board 11 by using the cellular phone 7, similarly to the case of the previous thermometer 1, the image capturing module 31 of the cellular phone 7 firstly recognizes the first frame 15, extracts the two-dimensional code 14 from an image inside the first frame 15 and outputs the extracted two-dimensional code 4 to the two-dimensional code analysis module 32. The two-dimensional code analysis module 32 performs the image analysis of the two-dimensional code 14 read from the image and outputs the extracted data to the control module 33. The control module 33 recognizes that the image classification behind the transparent acrylic board 11 specified by the second frame 16 is the meter based on the classification data described in the two-dimensional code 14. When recognizing that the image classification is the meter, the control module 33 determines that the image processing is carried out by the cellular phone 7 and the data server 9 in a sharing manner. That is, the control module 33 selects a procedure that the cellular phone 7 extracts outline data from the image 20 as the intermediate processed image data and the data server 9 finally extracts the indication data from the intermediate processed image data. In response to this selection, the control module 33 specifies the image analysis algorithm 34a which extracts the outline data from the image inside the second frame 16 and notifies the feature extracting module 34 of it.

Meanwhile, the image capturing module 31 recognizes the second frame 16, extracts the image inside the second frame 16 and outputs it to the feature extracting module 34. The feature extracting module 34 extracts the outline data by using the image analysis algorithm 34a specified by the control module 33 and outputs the outline data to the control module 33 as the intermediate processed image data. The control module 33 acquires the URL of the storage location of the data such as a communication address of the server of the communication destination from the data extracted by the two-dimensional code analysis module 32, and transmits the image classification data, the intermediate processed image data and the URL of the storage location to the data server 9 through the wireless transmitting and receiving section 26. At that time, the control module 33 reads out the terminal identification code 27a, which indicates that the cellular phone 7 is unique in the system, from the ID section 27 and attaches it to the data.

The data transmitted from the cellular phone 7 reaches the control module 53 of the data server 9 through the network 8. The control module 53 of the data server 9 stores the intermediate processed image data temporarily into the storage device 24 based on the transmitted image classification data, assigns the analysis program 56a for the meter image from the analysis program library 56 and instructs the feature extracting module 54 to analyze the meter image. In the feature extracting module 54, the assigned analysis program 56a operates and extracts the feature from the intermediate processed image data. The image pattern comparing module 55 analyzes the numeral value indicated in the meter by reading the comparison image data 57a from the image pattern library 57 and comparing the comparison image data 57a with the image data that the feature extracting module 54 acquires by extracting the feature. The image pattern comparing module 55 outputs the analysis result to the control module 53. The control module 53 stores the analysis result into an area specified by the URL of the storage location, in the personal data accumulating area 51 specified by the terminal identification code 27a, every writing time known by the clock 44. As shown above, in the analysis of the image in the meter display section 12 of FIG. 2, based on the image classification data described in the two-dimensional code 14, the image analysis is performed by the cellular phone 7 and the data server in the sharing manner.

The read indication data can be used for application methods by the mashup, similar to the application example of the thermometer 1. Such indication data reading method can be used for patrol monitoring and abnormal warning in a factory. Incidentally, in the case of dealing with diverse image analysis algorithms and in the case of executing complicated analysis processing, the data server 9 can be entrusted with the image processing. In this case, since it is necessary to transmit the data of the image 20 without dropping down the feature from the cellular phone 7, the communications traffic increases.

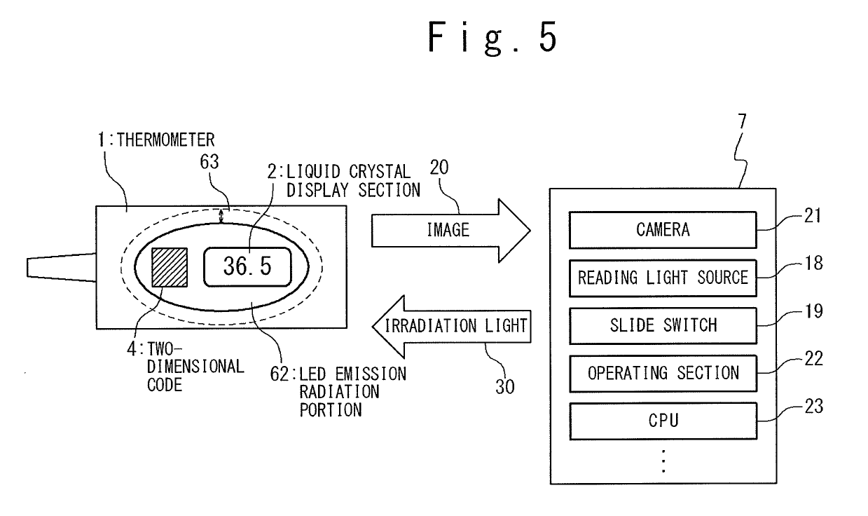

In the embodiment shown above, the stickers 3, 13 are used for the method of defining the two frames around the analysis object. However, the frames may be defined by a variety of methods other than the above. For example, as shown in FIG. 5, a reading light source 18 maybe provided in the cellular phone 7, and the first frame and the second frame may be defined by using irradiation light 30 from the reading light source 18.

In one embodiment, the first frame and the second frame may be defined by using an LED (light emitting diode) as the reading light source 18 and radiating alight beam from the LED. The image capturing module 31 can extract the portion surrounded by the first frame 5 of the sticker 3 of FIG. 1 from the image 20 because luminance of a LED emission radiation portion 62 where the light beam is radiated is different from that of the surroundings. In addition, the second frame 6 can be realized by providing a configuration that an optical reflectance of the liquid crystal display section 2 of the thermometer 1 is different from that of the surroundings.

Instead of the LED as the reading light source 18, a laser marker, which draws an image by reflecting a laser light by a mirror fabricated using a MEMS (Micro Electro Mechanical Systems) technique, may be used as the reading light source 18. By drawing images corresponding to the first frame 5 and the second frame 6 of the sticker 3 of FIG. 1 using the laser marker, the effect same as printing the frames on the sticker 3 can be obtained.

Here, an efficiency of the analysis processing is increased by applying a configuration that a radiating range or a drawing range of the reading light source 18 is variable by changing a focal length of a focus lens of the reading light source 18 based on an operation of a slide switch 19 or changing an operable range of the MEMS, because the image capturing module 31 can narrow the analysis range. For example, if the LED emission radiation portion 62 is narrowed as compared with an area indicated by a dash line 63 in FIG. 5, the analysis range can be narrowed.

Incidentally, to prevent confusion from occurring, the image classification code of the two-dimensional code, which is used for correlating to the image analysis algorithm and the analysis reference, and the URL information, which is used for correlating the server to the information reading object of the household device, is preferably managed in an integrated fashion by a system operator.

As described above, the data collection system of the present embodiment, since the image classification data is recorded in the two-dimensional code 4, 14, the image analysis algorithm and the reference image data can be appropriately selected, a variety of images can be widely handled and the accuracy of reading can be improved. In addition, by setting the first frame and the second frame preliminary to specify the analysis portion, the accuracy of reading can be improved. According to the system of the present embodiment, by extracting the information from the information indication which is only for human as an intended observer, and converting it to the digital data, the networked information processing service can be utilized. Information can be collected from electric devices with a low price which are not networked, and therefore, new added-value can be provided to them.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2009-237616 filed on Oct. 14, 2009, the disclosure of which is incorporated herein in its entirety by reference.

1. A data collection system comprising:
an image input means configured to be installed in a mobile terminal and acquire an analysis object image as an analysis object which is an image in a display device;
a code deciphering means configured to retrieve a code image portion which is an image of an optically readable code provided correspondingly to the analysis object from the analysis object image and extract a description of the code from the code image portion;
an image analysis means configured to select an image analysis algorithm based on image classification data included in the description of the code and extract indication data of the display device by performing image analysis on the analysis object image using the selected image analysis algorithm; and
a server configured to include a data storage section which stores the indication data and be capable of communicating with the mobile terminal.

2. The data collection system according to claim 1, wherein the code deciphering means recognizes a first frame contained in the analysis object image and retrieve the code image portion from an image inside the first frame, and
wherein the image analysis means recognizes a second frame contained in the image inside the first frame and extracts the indication data by analyzing an image inside the second frame using the image analysis algorithm.

3. The data collection system according to claim 2, wherein the mobile terminal includes a light source configured to radiate an irradiation light for specifying the first frame.

4. The data collection system according to claim 3, wherein a radiating rage of the irradiation light is variable.

5. The data collection system according to claim 1, wherein the code deciphering means is provided in the mobile terminal,
wherein the image analysis means is provided in the mobile terminal and includes a mobile terminal side image analysis means configured to extract the indication data from the analysis object image, and
wherein the mobile terminal transmits the indication data acquired by the mobile terminal side image analysis means to the server.

6. The data collection system according to claim 1, wherein the code deciphering means is provided in the mobile terminal,
wherein the image analysis means includes:
a mobile terminal side image analysis means configured to be provided in the mobile terminal, and
a server side image analysis means configured to be provided in the server,
wherein the mobile terminal side image analysis means has a function that creates intermediate processed image data by performing image processing on the analysis object image,
wherein the mobile terminal is configured to transmit the intermediate processed image data to the server,
wherein the server side image analysis means extracts the indication data by performing image processing on the intermediate processed image data, and
wherein the server is configured to store the indication data acquired by the server side image analysis means into the data storage section.

7. The data collection system according to claim 6, wherein when the image classification data contained in a description of the code indicates a first image classification, the mobile terminal side image analysis means selects a first image analysis algorithm in which the indication data is extracted by the mobile terminal side image analysis means, and the mobile terminal transmits the indication data acquired by the mobile terminal side image analysis means to the server, and
wherein when the image classification data contained in a description of the code indicates a second image classification, the mobile terminal side image analysis means selects a second image analysis algorithm in which the indication data is extracted by the mobile terminal side image analysis means and the server side image analysis means in a sharing manner, the mobile terminal transmits the intermediate processed image data acquired by the mobile terminal side image analysis means to the server, and the server side image analysis means extracts the indication data by performing image analysis on the intermediate processed image data.

8. The data collection system according to claim 1, wherein a description of the code contains storage location information which indicates a storage location of the indication data.

9. A mobile terminal comprising:
an image input means configured to acquire an analysis object image as an analysis object which is an image in a display device;
a code deciphering means configured to retrieve a code image portion which is an image of an optically readable code provided correspondingly to the analysis object from the analysis object image and extract a description of the code from the code image portion;
an image analysis means configured to select an image analysis algorithm based on image classification data included in the description of the code and perform image analysis on the analysis object image using the selected image analysis algorithm; and
a wireless transmitting and receiving section configured to transmit data obtained by the image analysis to a server.

10. The mobile terminal according to claim 9, wherein the code deciphering means recognizes a first frame contained in the analysis object image and retrieve the code image portion from an image inside the first frame, and
wherein the image analysis means recognizes a second frame contained in the image inside the first frame and performs the image analysis on an image inside the second frame.

11. The mobile terminal according to claim 10, wherein the mobile terminal includes a light source configured to radiate an irradiation light for specifying the first frame.

12. The mobile terminal according to claim 11, wherein a radiating rage of the irradiation light is variable.

13. The mobile terminal according to claim 9, wherein the image analysis means is configured to extract indication data of the display device from the analysis object image, and
wherein the wireless transmitting and receiving section transmits the indication data to the server.

14. The mobile terminal according to claim 9, wherein the image analysis means has a function that creates intermediate processed image data, which is used for extracting indication data of the display device at the server, by performing image processing on the analysis object image, and
wherein the wireless transmitting and receiving section is configured to transmit the intermediate processed image data to the server.

15. The mobile terminal according to claim 14, wherein when the image classification data contained in a description of the code indicates a first image classification, the image analysis means selects a first image analysis algorithm in which the indication data is extracted, and the wireless transmitting and receiving section transmits the indication data acquired by the image analysis means to the server, and
wherein when the image classification data contained in a description of the code indicates a second image classification, the image analysis means selects a second image analysis algorithm in which the intermediate processed image data is created from the analysis object image, and the wireless transmitting and receiving section transmits the intermediate processed image data acquired by the image analysis means to the server.

16. A sticker that is used for collecting data from a display device, comprising:
a first frame;
a code configured to be provided inside the first frame and optically readable; and
a second frame configured to be provided inside the first frame and located at a position corresponding to the display device,
wherein in the code, image classification data corresponding to an image analysis algorithm to be used for an image of the display device is described.

17. A data collection method comprising:
acquiring an analysis object image as an analysis object which is an image in a display device by an image input means installed in a mobile terminal;
retrieving a code image portion which is an image of an optically readable code provided correspondingly to the analysis object from the analysis object image;
extracting a description of the code from the code image portion;
selecting an image analysis algorithm based on image classification data included in the description of the code;
extracting indication data of the display device by performing image analysis on the analysis object image using the selected image analysis algorithm; and
storing the indication data in a server.

18. The data collection method according to claim 17, further comprising:
attaching a sticker on the display device, the sticker including a first frame, a second frame provided inside the first frame and located at a position corresponding to the display device, and the code provided inside the first frame,
wherein the step of retrieving the code image portion includes:
recognizing a first frame contained in the analysis object image, and
retrieving the code image portion from an image inside the first frame,
wherein the step of extracting the indication data includes:
recognizing a second frame contained in the image inside the first frame, and
extracting the indication data by analyzing an image inside the second frame using the image analysis algorithm.

19. The data collection method according to claim 17, further comprising:
putting a transparent board, on which a sticker is attached, on the display device, the sticker including a first frame, a second frame provided inside the first frame and located at a position corresponding to the display device, and the code provided inside the first frame,
wherein the step of retrieving the code image portion includes:
recognizing a first frame contained in the analysis object image, and
retrieving the code image portion from an image inside the first frame,
wherein the step of extracting the indication data includes:
recognizing a second frame contained in the image inside the first frame, and
extracting the indication data by analyzing an image inside the second frame using the image analysis algorithm.
